(19) United States
(12) Patent Application Publication
(10) Pub. No.: US 2025/0226475 A1
(43) Pub. Date: Jul. 10, 2025

(54) Devices and Methods for Thermal Energy Storage by Direct Evaporative Cooling

(71) Applicants: Patrick J. Shamberger, College Station, TX (US); Sourav Chakravarty, Bryan, TX (US)

(72) Inventors: Patrick J. Shamberger, College Station, TX (US); Sourav Chakravarty, Bryan, TX (US)

(73) Assignee: The Texas A&M University System, College Station, TX (US)

(21) Appl. No.: 19/013,400

(22) Filed: Jan. 8, 2025

Related U.S. Application Data
(60) Provisional application No. 63/618,661, filed on Jan. 8, 2024.

(51) Int. Cl. H01M 10/613

(52) U.S. Cl. CPC H01M 10/613

(57) ABSTRACT

Provided herein are direct evaporative cooling devices and systems that are in open and closed configurations for cooling hot solid components. The devices in both configurations generally have a casing with a perforated surface where sealed within are a water/vapor separator with a reservoir volume and a thermally conductive media therein through which heat evaporates water within the media such that evaporation cools the hot solid component. The closed configuration of the device includes a condensor to receive, recondense the vapor to water and re-inject the water into the reservoir volume.

### CROSS-REFERENCE TO RELATED APPLICATIONS

This non-provisional application claims benefit of priority under 35 U.S.C. § 119 (e) of provisional application U.S. Ser. No. 63/618,661, filed Jan. 8, 2024, the entirety of which is hereby incorporated by reference.

### FEDERAL FUNDING LEGEND

This invention was made with government support under Grant Number DE-AR0001357 awarded by the Advanced Research Projects Agency-Energy of the Department of Energy. The government has certain rights in the invention.

### BACKGROUND OF THE INVENTION

### Field of the Invention

This invention relates to the fields of thermal energy storage and evaporative cooling. More specifically, the present invention relates to devices and methods for direct evaporative cooling of a high power components.

### Description of the Related Art

Evaporative cooling has been used extensively for a variety of thermal management applications. Direct evaporative cooling of air and, to a lesser extent, indirect cooling of a gas, is a common strategy for cooling buildings in arid environments, such as the commonly known swamp cooler. Direct and indirect cooling of fluid loops is extensively used in power plants and for industrial cooling loops. Direct evaporative cooling of a solid has been utilized before, especially in cases where a hot component can be directly submerged in a fluid, for example, in 2-phase immersion cooling.

Thus, there remain unmet needs in the art for a direct evaporative cooler where the operation thereof does not require immersion of a solid device or component thereof in a tank or its integration into a fluid loop. Particularly, the art is deficient in thermal energy storage reservoirs and methods for direct evaporative cooling of hot components in solid devices

### SUMMARY OF THE INVENTION

The present invention is directed to a device for direct evaporative cooling of a power component. The device has a casing comprising a liquid/vapor separator that contains a reservoir volume therein. A thermally conductive, porous media comprising water is contained within the reservoir volume.

The present invention is directed to a related device further comprising a permeable hydrophobic membrane disposed around the thermally conductive, porous media. The present invention is directed to another related device comprising a condenser in fluid communication with the liquid/vapor separator.

The present invention also is directed to a method for direct evaporative cooling of a powered component. In the method the device described herein is positioned in direct contact with the powered component. Heat from the powered component into the thermally conductive, porous media is transported into the thermally conductive, porous media and the water is evaporated to vapor with the heat transported therein. The vapor is removed from the reservoir volume through the liquid/vapor separator.

The present invention is directed to a related method where the device comprises a condenser in fluid communication with the liquid/vapor separator such that the method further comprises flowing the vapor into the condenser and recondensing the vapor to water. The water is re-injected into the reservoir volume.

The present invention is directed further to an open system for direct evaporative cooling. The open system has a liquid/vapor separator that has a multi-layer mesh and a reservoir volume enclosed by a casing where the casing has one perforated surface. The reservoir volume contains water and a thermally conductive, porous media with a permeable hydrophobic membrane disposed therearound.

The present invention is directed further still to a closed system for direct evaporative cooling. The closed system is the same as the open system with the addition of a condenser in fluid communication with the reservoir volume of the liquid/vapor separator.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1D are cross-sectional views illustrating the direct evaporative cooling device and evaporative cooling in an open configuration (FIGS. 2A-2B) and a closed configuration (FIGS. 2C-2D).

FIGS. 2A-2B are views of the external volume of the direct evaporative cooling device.

FIGS. 3A-3D are images of different porous polytetrafluoroethylene (PTFE) sheets evaluated as liquid-vapor separators.

FIGS. 4A-4C show commercial high porosity open cell aluminum foams as-received (FIG. 4A) and after uniaxial compression (FIG. 4B). FIG. 4C illustrates a representative pore opening in an open-cell foam.

FIGS. 5A-5I show an array of simple cubic lattices printed with unit cells from about 0.75 mm to about 1.25 mm and printed strut diameters from about 0.4 to about 0.7 mm.

FIG. 6. shows the effects of surface treatment and aging on contact angles measured on flat aluminum surfaces after various surface treatments (averages of 4 repeat measurements, uncertainty bars show 20 variation).

FIGS. 7A-7B compare a cleaned aluminum foam which resists absorption of liquid water (FIG. 7A) with an anodization on the aluminum foam which helps to wick liquid water into the foam structure (FIG. 7B).

### DETAILED DESCRIPTION OF THE INVENTION

As used herein, the articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

As used herein, the term “or” in the claims refers to “and/or” unless explicitly indicated to refer to alternatives only or the alternatives are mutually exclusive, although the disclosure supports a definition that refers to only alternatives and “and/or”.

As used herein “another” or “other” may mean at least a second or more of the same or different claim element or components thereof.

As used herein, the terms “comprise” and “comprising” are used in the inclusive, open sense, meaning that additional elements may be included.

As used herein, the terms “consist of” and “consisting of” are used in the exclusive, closed sense, meaning that additional elements may not be included.

As used herein, the term “about” refers to a numeric value, including, for example, whole numbers, fractions, and percentages, whether or not explicitly indicated. The term “about” generally refers to a range of numerical values (e.g., +5-10% of the recited value) that one of ordinary skill in the art would consider equivalent to the recited value (e.g., having the same function or result). In some instances, the term “about” may include numerical values that are rounded to the nearest significant figure. In a non-limiting example the heating limit of about 120° C. encompasses temperatures of 108° C. to 132° C.

In one embodiment of the present invention, there is provided a device for direct evaporative cooling of a power component, comprising a casing comprising a liquid/vapor separator that contains a reservoir volume therein; and a thermally conductive, porous media comprising water contained within the reservoir volume.

Further to this embodiment the device comprises a permeable hydrophobic membrane disposed around the thermally conductive, porous media. In another further embodiment the device comprises a condenser in fluid communication with the liquid/vapor separator.

In all embodiments the casing may comprise one perforated surface. Also in all embodiments the liquid/vapor separator may comprise a multi-layer mesh. In addition the thermally conductive, porous media may be an open cell metal foam or a 3D metal lattice. In an aspect thereof the metal in the thermally conductive, porous media may be anodized. Furthermore, the liquid/vapor separator is a thermal energy storage reservoir.

In another embodiment of the present invention there is provided a method for direct evaporative cooling of a powered component, comprising a) positioning the device as described supra in direct contact with the powered component; b) transporting heat from the powered component into the thermally conductive, porous media; c) evaporating the water to vapor with the heat transported therein; and d) removing the vapor from the reservoir volume through the liquid/vapor separator. Further to this embodiment the device comprises a condenser in fluid communication with the liquid/vapor separator where the method comprises e) flowing the vapor into the condenser; f) recondensing the vapor to water; and g) re-injecting the water into the reservoir volume.

In both embodiments the liquid/vapor separator may absorb heat at a gravimetric energy density greater than 1 KJ/g. Also in both embodiments the powered component may be an electric motor or a battery.

In yet another embodiment of the present invention there is provided an open system for direct evaporative cooling, comprising a liquid/vapor separator comprising a multi-layer mesh and having a reservoir volume enclosed by a casing having one perforated surface; said reservoir volume containing water and a thermally conductive, porous media with a permeable hydrophobic membrane disposed therearound.

In this embodiment the reservoir volume may be a thermal energy storage reservoir. Also in this embodiment the thermally conductive, porous media may be an open cell metal foam or a 3D metal lattice. In an aspect thereof the thermally conductive, porous media may be anodized.

In yet another embodiment of the present invention there is provided a closed system for direct evaporative cooling, comprising a liquid/vapor separator comprising a multi-layer mesh and having a reservoir volume enclosed by a casing having one perforated surface; said reservoir volume containing water and a thermally conductive, porous media with a permeable hydrophobic membrane disposed therearound; and a condenser in fluid communication with the reservoir volume of the liquid/vapor separator. In this embodiment the reservoir volume, the thermally conductive porous media and the metal comprising the same all are as described supra.

Provided herein are devices comprising a liquid-vapor separator with a very small pressure drop in vapor, while maintaining a resilient liquid barrier and a porous thermally conductive wick that enables direct evaporative cooling of a hot solid component. The device is used as a self-contained thermal energy storage reservoir that provides cooling when the liquid therein, for example, water, evaporates. The device is designed for direct cooling of a solid device or component thereof, such as, but not limited to, high power components and systems, for example, electric motors and batteries, to limit over-heating when operated under high power conditions as are known in the art. The device relies on thermally conductive porous media to transport heat away from the hot component of the solid, and to increase the hot area over which evaporation occurs. The use of an enclosed volume enables evaporative cooling without immersion of the entire solid device in a tank.

The device has two distinct different embodiments, each of which are advantageous under certain conditions. If the evaporative cooling device is used as an open system with no condenser where evaporated water is ejected directly to the atmosphere, then the evaporative cooling device is a thermal energy storage reservoir that absorbs large quantities of heat at a very high gravimetric energy density (>1 KJ/g). Alternatively, if the evaporative cooling device is used as a closed system where vapor is collected, re-condensed, and re-injected into the reservoir for later use, the device is similar to a cooling loop integrated directly with a hot solid device or component thereof.

In a non-limiting example, direct evaporative cooling is used to cool hot windings for an electric motor. Specifically, a reservoir volume is contained within a sealed casing that has one perforated surface that includes a vapor-permeable liquid/vapor separator to contain liquid within the casing, but also provide an easy path for vapor to leave the system. The interior volume of the casing is occupied by a high porosity, hydrophilic, thermally conductive wick that serves to wick fluid evenly throughout the reservoir volume, and to transport heat from the hot windings throughout the volume to evaporate the liquid, for example, water, along extended surfaces.

As described below, the invention provides a number of advantages and uses, however such advantages and uses are not limited by such description. Embodiments of the present invention are better illustrated with reference to the Figure(s), however, such reference is not meant to limit the present invention in any fashion. The embodiments and variations described in detail herein are to be interpreted by the appended claims and equivalents thereof.

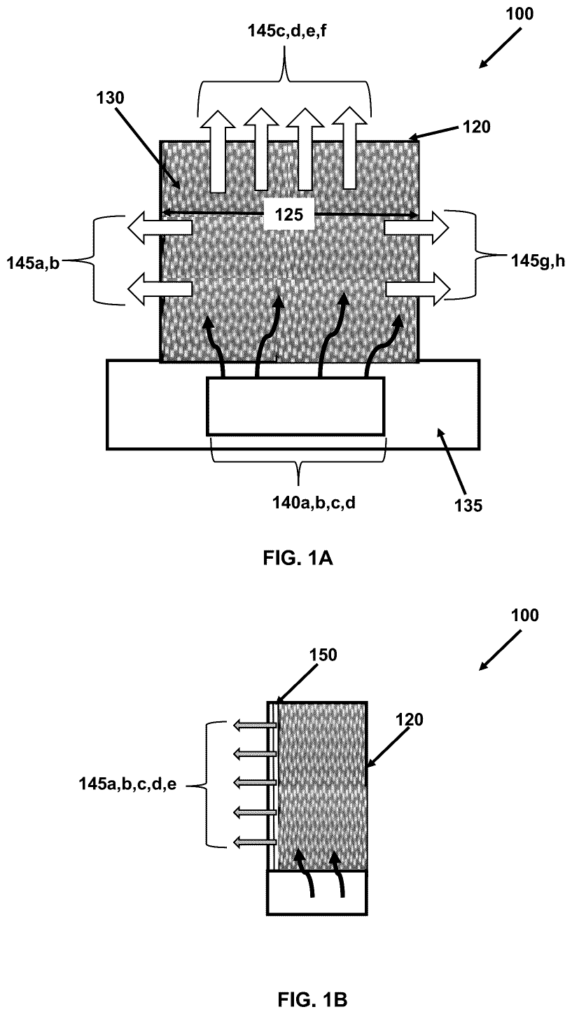

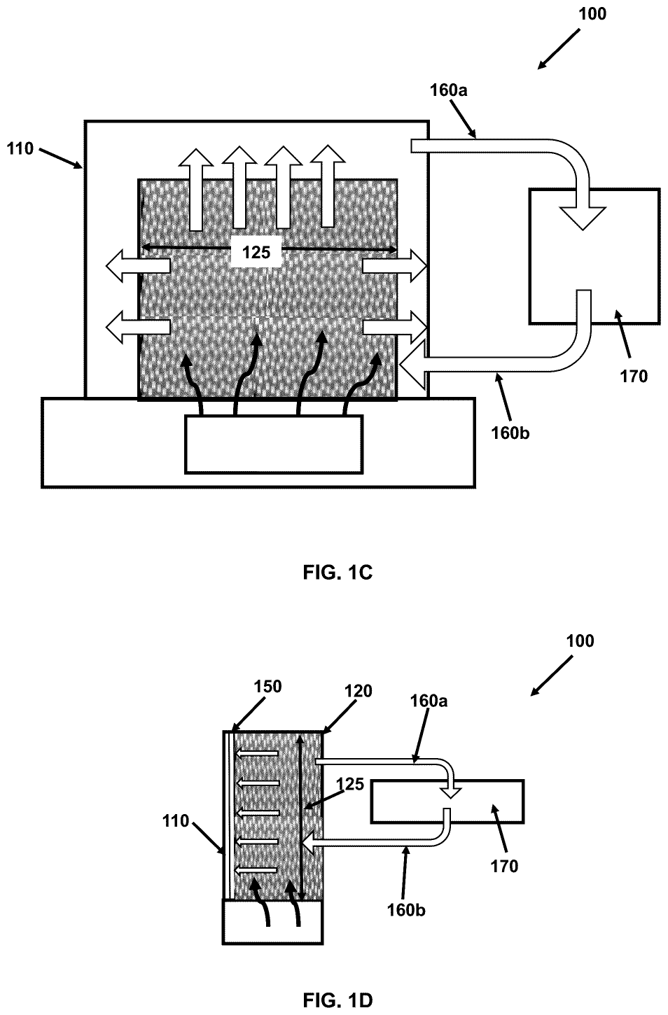

FIG. 1A shows the direct evaporative cooling device in an open configuration 100. The direct evaporative cooling device has a sealed casing 110 (see FIG. 1B) except for one perforated surface 115 (see FIG. 2A) that encloses a water/vapor separator 120. The water/vapor separator has a reservoir 125 that contains a thermally conductive, porous media 130 incorporating water. The direct evaporative cooling device is configured to integrate with a powered solid device or component thereof 135 such that heat 140a,b,c,d generated therefrom is transferred into the water in the thermally conductive porous media. The heat evaporates the water where the resultant vapor is transferred out of the water/vapor separator via a wicking action at 145a,b,c,d,e,f,g,h through a permeable hydrophobic membrane 150 disposed around the thermally conductive, porous media (see FIG. 1B). The water/vapor separator functions as a thermal energy storage reservoir and enables the direct evaporative cooling device to reduce the temperature of the hot component in the solid device when it reaches about 120° C.

With continued reference to FIG. 1A, FIG. 1B is a cross-sectional view of the open configuration of the direct evaporative cooling device 100. The transfer of the vapor from the water/vapor separator 120 at 145a,b,c,d,e through the permeable hydrophobic membrane 150 is illustrated.

With continued reference to FIGS. 1A-1B, FIG. 1C shows the direct evaporative cooling device 100 in a closed configuration. The vapor is transferred from the casing 110 to a condenser 170 along 160a where it recondenses to water and is transferred along 160b back into the reservoir 125 for reuse.

With continued reference to FIGS. 1A-1C, FIG. 1D is a cross-sectional view of the closed configuration of the direct evaporative cooling device 100. The transfer of the vapor from the water/vapor separator 120 through the permeable hydrophobic membrane 150 into the casing 110 for collection, transfer to the condenser 170 at 160a for recondensation to water and transfer into the reservoir 125 at 160b is illustrated.

FIGS. 2A-2B are respective 3-dimensional and cross-sectional views of the direct evaporative cooling device 100 in the open configuration. The views illustrate the arrangement of the sealed casing 110 with one perforated surface 115, the water/vapor separator 120 containing the thermally conductive porous media 130, for example, but not limited to, an aluminum foam, and the permeable hydrophobic membrane 150.

The following examples are given for the purpose of illustrating various embodiments of the invention and are not meant to limit the present invention in any fashion.

### Example 1

### Materials

### Liquid/Vapor Separator

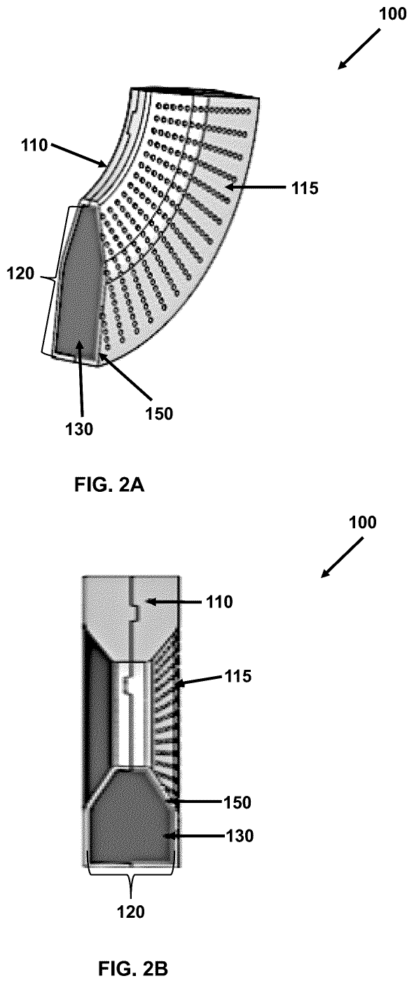

Porous polytetrafluoroethylene (PTFE) sheets that are stable to 260° C. are evaluated (FIGS. 3A-3D). Examples of porous PTFE sheets are PTFE-coated fiberglass mesh fabric sheets (FIG. 3A), rigid high-temperature plastic mesh (FIGS. 3B-3C) and porous PTFE membrane with sub-μm diameter holes (FIG. 3D). The liquid-vapor separator employed here is a multi-layer mesh structure with different size slits. Both porosity and pore size is controllable during the manufacturing process. Furthermore, porosity and anisotropic thermal conductivity can be modified after the fact by compaction. The purpose of the liquid-vapor separator is to contain fluid within the reservoir, while simultaneously enabling an easy path of vapor transport out of the system.

### High Thermal Conductivity Porous Wick

The purpose of the high thermal conductivity wick is to 1) transport heat away from the hot surface, 2) to wick moisture evenly throughout the reservoir volume to avoid any maldistribution, and 3) to allow pathways for easy transport of vapor out of the reservoir volume.

### Open Cell Metal Foams

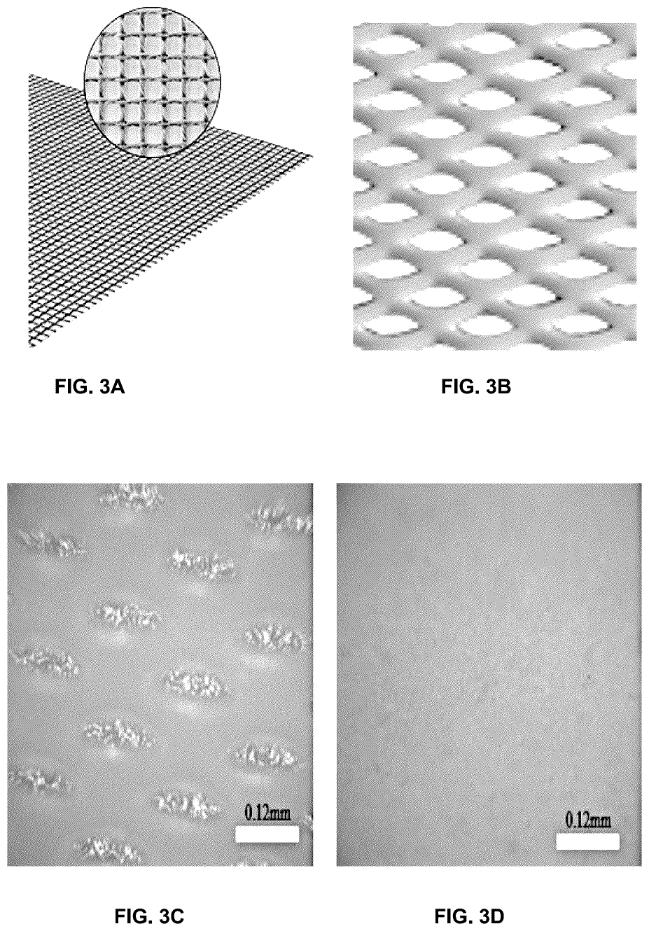

Commercial open-cell aluminum foams (generally made from Al 6061-T6), with small pore sizes (40 PPI) and moderate relative densities (<10%) represent one viable wick structure. Furthermore, these foams can be compacted by factors of 2× to 4×, to increase the relative density of the foam, and therefore to distort the pores uniaxially from a spherical pore to a flattened sphere (FIGS. 4A-4C). These foams are scalable, and are able to be produced monolithically to occupy the desired area.

### 3D Printed Metal Lattices

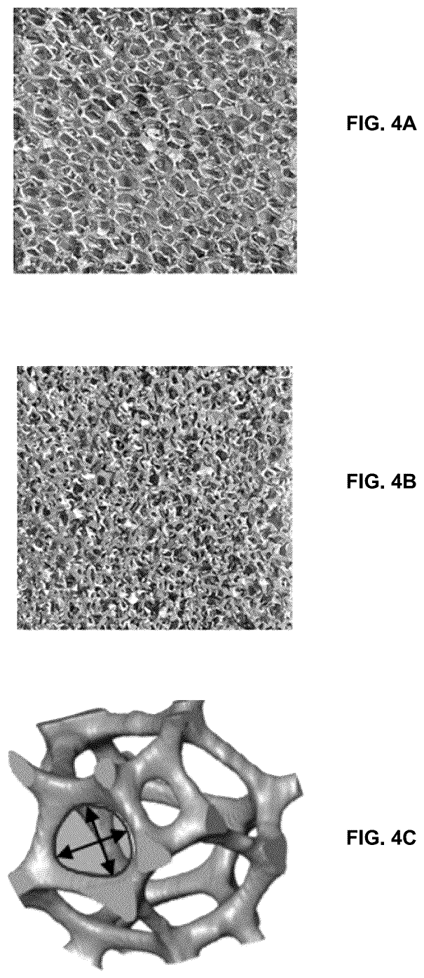

Similarly, printed metal lattices, for example, by laser powder bed fusion, or direct energy deposition, of Al—Si alloys represent an alternative strategy. These include multiple different lattice geometries, such as simple cubic or bcc. Lattices vary both in unit cell length of about 0.75 to about 1.25 mm and strut diameter of about 0.4 mm to about 0.7 mm. This results in porosities between 0.07 to 0.72. Table 1 lists the dimensions of unit cell length and strut diameter for each simple cubic lattice shown in FIGS. 5A-5I.

TABLE 1
Lattice unit cell dimensions

| | | |
|---|---|---|
| | Unit Cell | Strut |
| FIGS. | Length | Diameter |

| | | | |
|---|---|---|---|
| 5A | 0.75 | mm | 0.7 mm |
| 5B | 0.75 | mm | 0.5 mm |
| 5C | 0.75 | mm | 0.4 mm |
| 5D | 1 | mm | 0.7 mm |
| 5E | 1 | mm | 0.5 mm |
| 5F | 1 | mm | 0.5 mm |
| 5G | 1.25 | mm | 0.7 mm |
| 5H | 1.25 | mm | 0.4 mm |
| 5I | 1.25 | mm | 0.4 mm |

### Example 2

### Surface Treatment of a Porous Metal Wick

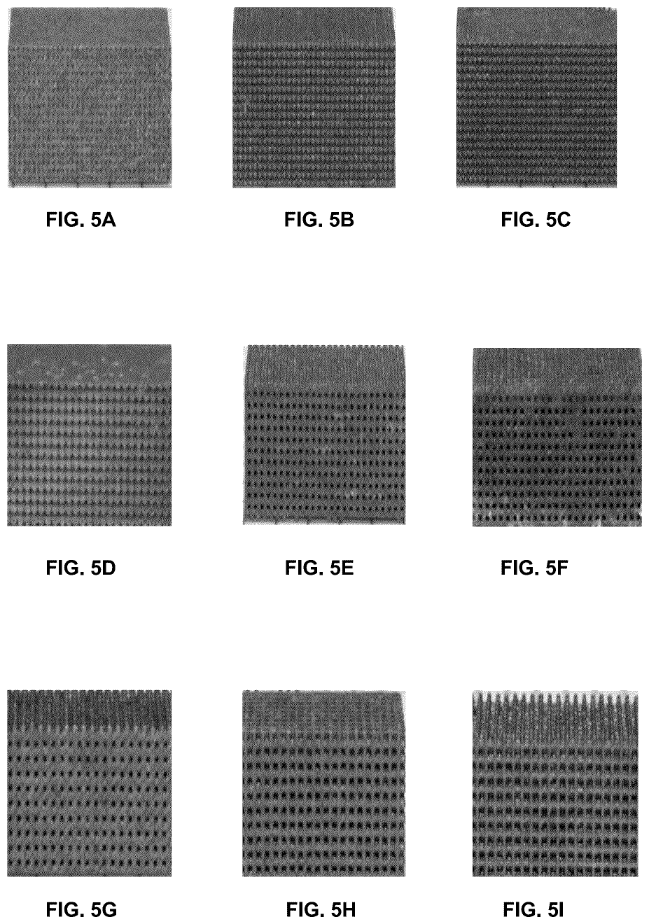

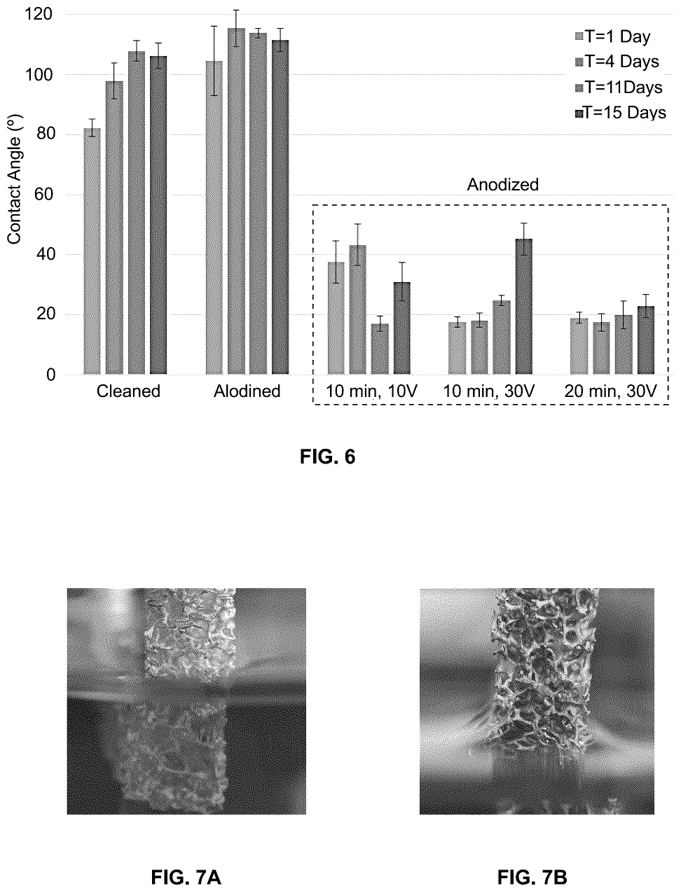

Surface treatments of a porous metal wick serve two purposes: 1) protection of the material from corrosion, and 2) increased hydrophilic nature of the metal surface, which increases wicking into the internal porous metal structure. Surface contact angles were evaluated on flat aluminum coupons that had been 1) cleaned using a commercial metal cleaner (Henkel Loctite Bonderite C-IC 33 AERO), 2) that had subsequently been reacted with a commercial Alodine chemfilm treatment (Henkel Alodine 1201), or 3) that had been subsequently anodized under 3 unique conditions (10 V/10 min; 10 V/30 min; 20 V/30 min). Contact angles (averages of 4 independent measurements) were measured after increasing periods of time (1 day, 4 days, 11 days, and 15 days). These results illustrated that anodization produced the most marked decrease in contact angle, that the change in contact angle was relatively insensitive to the conditions of anodization, and that the modification remained hydrophilic after an extended period of time exposed to lab air (FIG. 6, FIGS. 7A-7B). This approach aided in wicking of water into the porous foam.

What is claimed is:

1. A device for direct evaporative cooling of a power component, comprising:
a casing comprising a liquid/vapor separator that contains a reservoir volume therein; and
a thermally conductive, porous media comprising water contained within the reservoir volume.

2. The device of claim 1, wherein the casing comprises one perforated surface.

3. The device of claim 1, further comprising a permeable hydrophobic membrane disposed around the thermally conductive, porous media.

4. The device of claim 1, wherein the liquid/vapor separator comprises a multi-layer mesh.

5. The device of claim 1, wherein the thermally conductive, porous media is an open cell metal foam or a 3D metal lattice.

6. The device of claim 5, wherein the metal in the thermally conductive, porous media is anodized.

7. The device of claim 1, wherein the liquid/vapor separator is a thermal energy storage reservoir.

8. The device of claim 1, further comprising a condenser in fluid communication with the liquid/vapor separator.

9. A method for direct evaporative cooling of a powered component, comprising:
a) positioning the device of claim 1 in direct contact with the powered component;
b) transporting heat from the powered component into the thermally conductive, porous media;
c) evaporating the water to vapor with the heat transported therein; and
d) removing the vapor from the reservoir volume through the liquid/vapor separator.

10. The method of claim 9, wherein the liquid/vapor separator absorbs heat at a gravimetric energy density greater than 1 KJ/g.

11. The method of claim 9, wherein the device further comprises a condenser in fluid communication with the liquid/vapor separator, the method further comprising:
e) flowing the vapor into the condenser;
f) recondensing the vapor to water; and
g) re-injecting the water into the reservoir volume.

12. The method of claim 9, wherein the powered component is an electric motor or a battery.

13. An open system for direct evaporative cooling, comprising:
a liquid/vapor separator comprising a multi-layer mesh and having a reservoir volume enclosed by a casing having one perforated surface; said reservoir volume containing water and a thermally conductive, porous media with a permeable hydrophobic membrane disposed therearound.

14. The open system of claim 13, wherein the reservoir volume is a thermal energy storage reservoir.

15. The device of claim 13, wherein the thermally conductive, porous media is an open cell metal foam or a 3D metal lattice.

16. The device of claim 15, wherein the metal in the thermally conductive, porous media is anodized.

17. A closed system for direct evaporative cooling, comprising:
a liquid/vapor separator comprising a multi-layer mesh and having a reservoir volume enclosed by a casing having one perforated surface; said reservoir volume containing water and a thermally conductive, porous media with a permeable hydrophobic membrane disposed therearound; and
a condenser in fluid communication with the reservoir volume of the liquid/vapor separator.

18. The open system of claim 17, wherein the reservoir volume is a thermal energy storage reservoir.

19. The device of claim 17, wherein the thermally conductive, porous media is an open cell metal foam or a 3D metal lattice.

20. The device of claim 19, wherein the metal in the thermally conductive, porous media is anodized.
